(19) United States
(12) Patent Application Publication
(10) Pub. No.: US 2025/0243054 A1
(43) Pub. Date: Jul. 31, 2025

(54) INTEGRATED HYDROGEN PRODUCTION AND CHARGING SYSTEM AND METHOD THEREOF

(71) Applicant: CHUNG-HSIN ELECTRIC & MACHINERY MFG. CORP., Taoyuan City (TW)

(72) Inventors: Chien Hao CHEN, Taoyuan City (TW); Chin Hsien CHENG, Taoyuan City (TW)

(21) Appl. No.: 18/428,159

(22) Filed: Jan. 31, 2024

(51) Int. Cl. C01B 3/32; B01D 53/04; B01D 53/053; B01D 53/22; B01D 71/02; C01B 3/00; C01B 3/50; C01B 3/56; F17C 5/06; H01M 8/04082; H01M 8/04089; H01M 8/0612; H01M 8/0662

(52) U.S. Cl. CPC C01B 3/323; B01D 53/0438; B01D 53/053; B01D 53/228; B01D 53/229; B01D 71/02231; C01B 3/0031; C01B 3/505; C01B 3/506; C01B 3/56; F17C 5/06; B01D 2053/221; B01D 2257/7025; B01D 2257/80; B01D 2259/40007; C01B 2203/0227; C01B 2203/0405; C01B 2203/042; C01B 2203/046; C01B 2203/0495; C01P 2006/82; F17C 2203/0648; F17C 2221/012; F17C 2225/035; F17C 2227/0157; F17C 2227/0327; F17C 2227/0348; F17C 2227/0365; H01M 8/04089; H01M 8/04216; H01M 8/0618; H01M 8/0687

(57) ABSTRACT

The present invention provides an integrated hydrogen production and charging system, including a hydrogen generator, a compressor, a heat exchanger, a pressure swing adsorption device, a vacuum pump, and a hydrogen charger. The hydrogen generator generates hydrogen by methanol reforming. The hydrogen generator makes the generated hydrogen pass through a palladium membrane purification device in the hydrogen generator for a first purification. The compressor compresses the hydrogen from the hydrogen generator. The heat exchanger, connected to the compressor, cools down the compressed hydrogen. The pressure swing adsorption device, connected to the heat exchanger, performs a second purification on the cooled down hydrogen by adsorption. The vacuum pump, connected to the pressure swing adsorption device, depressurizes the pressure swing adsorption device during desorption. The hydrogen charger charges the hydrogen from the pressure swing adsorption device into one or more metal alloy hydrogen storage tanks.

### BACKGROUND OF THE INVENTION

### Field of the Invention

The present invention relates to a technique for producing and charging hydrogen, and, in particular, it relates to an integrated hydrogen production and charging system.

### Description of the Related Art

Hydrogen energy is one of the new energy sources whose popularity is booming today. Compared with new energy sources such as wind energy and solar energy, the advantage of hydrogen energy is that it is not limited by the natural environment, so it can perform energy conversion stably. Today, hydrogen energy is one of the main fuel sources for fuel cells. In addition to the usage as a fuel source for fuel cells, hydrogen energy can also be used in the petroleum industry, the steel industry, or the food-processing industry. With the development of fuel-cell technology, hydrogen producing devices, and hydrogen supplying devices that supply hydrogen to fuel cells, are also continuously undergoing innovation.

At present, the main industrial methods for hydrogen production involve steam reforming of hydrocarbons (such as natural gas and methanol). Additionally, hydrogen gas can be obtained as a byproduct of certain chemical reactions. There are also various other methods for hydrogen production, including electrolysis and thermolysis. Currently, scientists are striving to discover large-scale and cost-effective methods for hydrogen production to meet economic viability.

Generally speaking, the hydrogen produced by a hydrogen production device needs to be stored in compressed or liquefied form (for example: hydrogen is stored in steel cylinders in compressed form, or in alloys or carbon nanotubes), so as to avoid effusion into the atmosphere. However, using the compressed hydrogen storage method as an example, if the stored hydrogen is going to be supplied to fuel cells, the compressed hydrogen must be decompressed before being used. In addition to the increased time and cost associated with this process, the steps of compression and decompression also increase the safety risks inherent in the hydrogen production process and the hydrogen supply process.

The spate of hydrogen energy safety incidents around the world in recent years has put the construction and operation of hydrogen refueling stations under great scrutiny. As a result, the safety technical threshold and construction requirements of general high-pressure hydrogen refueling infrastructure continue to rise, deterring some investors who might otherwise be interested in hydrogen energy, which undoubtedly restricts the promotion of hydrogen energy and fuel cells. In addition, since hydrogen is prone to leakage during storage and transportation, the safety and economy of hydrogen storage and transportation are also issues that cannot be ignored.

Therefore, there remain many challenges in establishing a hydrogen supply chain.

### BRIEF SUMMARY OF THE INVENTION

An embodiment of the present invention provides an integrated hydrogen production and charging system, including a hydrogen generator, a compressor, a heat exchanger, a pressure swing adsorption device, a vacuum pump, and a hydrogen charger. The hydrogen generator generates hydrogen by methanol reforming. The hydrogen generator makes the generated hydrogen pass through a palladium membrane purification device in the hydrogen generator for a first purification. The compressor compresses the hydrogen from the hydrogen generator. The heat exchanger is connected to the compressor. The heat exchanger cools down the compressed hydrogen. The pressure swing adsorption device is connected to the heat exchanger. The pressure swing adsorption device performs a second purification on the cooled down hydrogen by adsorption. The vacuum pump is connected to the pressure swing adsorption device. The vacuum pump depressurizes the pressure swing adsorption device during desorption. The hydrogen charger charges the hydrogen from the pressure swing adsorption device into one or more metal alloy hydrogen storage tanks.

An embodiment of the present invention provides an integrated hydrogen production and charging method that comprises the following steps performed in sequence. A hydrogen production step uses a methanol solution in a methanol reforming reaction to synthesize hydrogen. A first purification step purifies the hydrogen synthesized by the hydrogen production step through a palladium membrane purification device. After the first purification step, a compression step compresses the hydrogen. After the compression step, a cooling step cools down the hydrogen. After the cooling step, a second purification step purifies the hydrogen through a pressure swing adsorption device. After the second purification step, a hydrogen charging step charges the hydrogen into one or more metal alloy hydrogen storage tanks.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 shows a schematic diagram of an integrated hydrogen production and charging system, according to some embodiments of the present disclosure.

FIG. 2 shows a flow chart of an integrated hydrogen production and charging method, according to some embodiments of the present disclosure.

FIG. 3 shows a flow chart of a second purification step in the integrated hydrogen production and charging method, according to some embodiments of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting.

Here, the terms “about”, “approximately” and “substantially” usually mean within 20%, preferably within 10%, and more preferably within 5% of a given value or range, or within 3%, or within 2%, or within 1%, or within 0.5%. It should be noted that the quantities provided in the disclosure are approximate quantities, that is, in the absence of specific descriptions of “about”, “approximately” and “substantially”, it may still implied the meaning of “about”, “approximately” and “substantially”. The terms “including”, “comprising”, “having” and variations thereof mean “including but not limited to”, unless specifically stated otherwise. The term “connect” includes direct connection and indirect connection. For example, the referring of a first feature connect to a second feature in the description that follows may include embodiments in which the first and second features are formed in direct contact, and may also include embodiments in which additional features may be formed between the first and second features, such that the first and second features are in indirect contact. Unless otherwise stated, terms “first” and “second” are used for descriptive purposes only, and should not be interpreted as indicating or implying relative importance or implying the number of indicated technical features.

In order to further promote the application of hydrogen energy, the present disclosure provides an integrated low-pressure hydrogen production and charging system, which produces hydrogen with methanol solution reforming and charges hydrogen into metal alloy hydrogen storage tanks. At a certain temperature and pressure, the hydrogen storage alloy in the metal alloy hydrogen storage tank undergoes a reversible reaction with hydrogen to form a metal solid solution and a metal hydride. This reversible reaction releases heat when adsorbing hydrogen gas and absorbs heat when releasing hydrogen gas. Since the metal alloy hydrogen storage tank belongs to low-pressure hydrogen storage with the tank pressure lower than 300 psig at 35° C., even if the tank is cracked, it will not cause an explosion, and the gas release rate can be self-limited. Compared with the high-pressure hydrogen storage with pressure, for example, about 5000-10,000 psig, the metal alloy hydrogen storage tanks have high safety, so the infrastructure with metal alloy hydrogen storage tanks is cost-effective, and it is easier and quicker to achieve universal access.

Hereinafter, according to some embodiments, the structure of the integrated hydrogen production and charging system will be further described in detail.

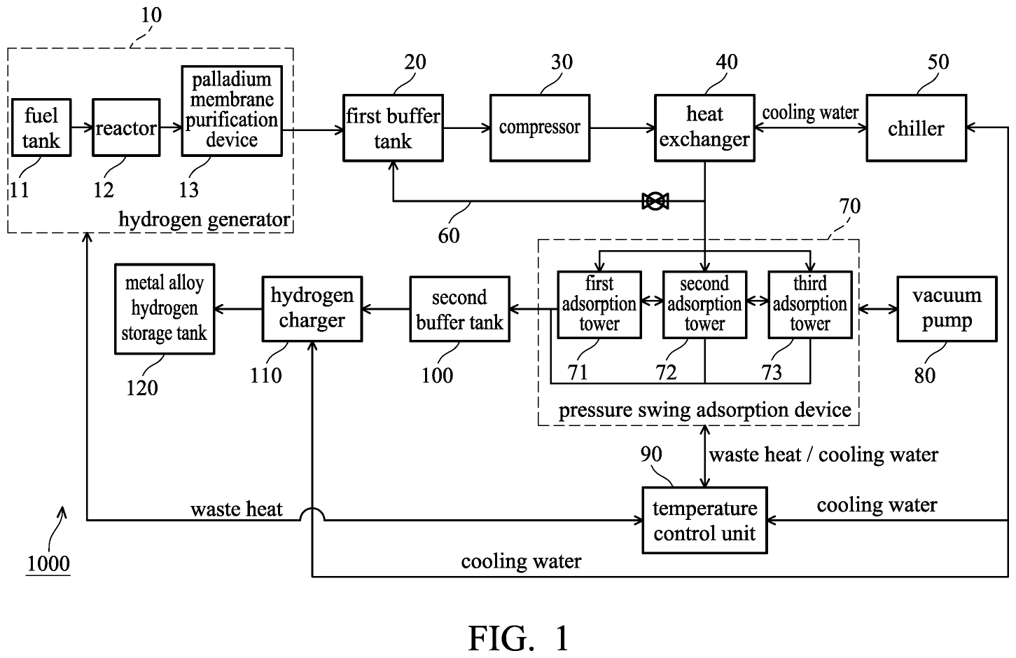

Referring to FIG. 1, which illustrate the schematic diagram of an integrated hydrogen production and charging system, according to some embodiments of the present disclosure. As shown in FIG. 1, the integrated hydrogen production and charging system 1000 sequentially includes, mainly, a hydrogen generator 10, a compressor 30, a heat exchanger 40, a pressure swing adsorption device 70, a vacuum pump 80, and a hydrogen charger 110.

In some embodiments, the hydrogen generator 10 includes: a fuel tank 11, a reactor 12, a palladium membrane purification device 13, etc. The hydrogen generator 10 uses the methanol solution stored in the fuel tank 11, and the methanol solution is reformed to generate hydrogen within reactor 12. The first purification is performed to the generated hydrogen in the palladium membrane purification device 13. The present disclosure utilizes the methanol reforming process to generator hydrogen, which is well-established, stable in hydrogen production, has compact equipment, can start-up fast, and has lower operating cost than other hydrogen production methods. In addition, the methanol solution can be stored and transported in liquid form, and it can produce the hydrogen on-demand based on the hydrogen demanding.

In some embodiments, the hydrogen-rich gas generated by the reactor 12 is unpurified, and the hydrogen concentration is between 60% and 72%. In some embodiments, the reactor 12 may perform steam reforming under proper temperature (for example, from 270° C. to 450° C.) with proper catalyst. Under the action of the steam reforming catalyst, the methanol solution undergoes the methanol cracking reaction and the water-gas shift reaction, and the reaction equation may be presented as following: (1) methanol cracking reaction: CH₃OH→CO+2H₂, (2) water-gas shift reaction: CO+H₂O←→CO₂+H₂, (3) actual steam reforming: CH₃OH+H₂O→xCO₂+yCO+zCH₄+mH₂+nH₂O. The generated gas after methanol reforming is hydrogen-rich gas, which has the hydrogen concentration of only 60-70%, and still includes CO, CO₂, CH₄, and some moisture. In some embodiments, the mechanism of hydrogen producing of reactor 12 may be autothermal steam reforming (ATR).

In some embodiments, the palladium membrane purification device 13 is a flat-plate purification module, which is characterized with its material not being traditional cylindrical porous ceramic with surface coating process, but being composed of thin-film stacks. The palladium membrane purification device 13 may purify the hydrogen-rich gas generated by the hydrogen generator 10, remove carbon dioxide, carbon monoxide, methane, or unreacted methanol precursors produced by the steam reforming reaction, and make the gas into high-purity hydrogen. In some embodiments, the purity of the hydrogen after the purification of the palladium membrane purification device 13 may reach higher than 99.95%. In some embodiments, the palladium membrane purification device 13 is a palladium alloy module formed by stacked palladium alloy thin films. In some embodiments, the palladium membrane purification device 13 is a palladium alloy module formed by stacked palladium alloy thin films with 60% by weight of palladium and 40% by weight of copper.

However, the storage alloy for hydrogen storing is highly sensitive to impurity gas, and the hydrogen stored therein needs to meet conditions such as purity higher than 99.99%, water content less than 5 ppmv, carbon monoxide less than 1 ppmv, carbon dioxide less than 3 ppmv, methane less than 10 ppmv, etc. Methane generated by CO methanation can seriously affect the performance of hydrogen storage alloys. In addition, since the pressure of the hydrogen produced by methanol solution reforming is reduced through purification steps such as that of palladium membrane, the hydrogen cannot be charged into the metal alloy hydrogen storage tank directly. Therefore, the present invention further compresses and purifies the hydrogen, which will be described in detail below.

The compressor 30 is used to compress the hydrogen from the hydrogen generator 10. According to some embodiments, the compressor 30 is a diaphragm compressor. The heat exchanger 40 is connected to the compressor 30 and is used to cool down the compressed hydrogen. The temperature of the hydrogen compressed by the compressor 30 may rise to above 300° C. before entering adsorption device 70, and water condensation may occur. Through the heat exchanger 40, the temperature of the hydrogen may cool down to about 30° C., and the water condensation may be eliminated, which avoids the water removal efficiency of the pressure swing adsorption device 70 being affected and avoids the adsorption efficiency of the pressure swing adsorption device 70 being affected by the increase of the temperature of the compressed hydrogen.

The pressure swing adsorption device 70 is connected to the heat exchanger 40 and is used to perform a second purification to the cooled down hydrogen by adsorption. Pressure swing adsorption (PSA) is a gas purification method that mainly utilizes adsorbents with different adsorption capacity on different substances to remove impurities. Under high pressure, impurities in the gas to be purified are adsorbed on the adsorbent, thus allowing the gas mixture to be separated. Thereafter, the adsorbents are regenerated by changing the pressure of the adsorbent to achieve the desorption of impurities, and the adsorbents can be used again in the adsorption step in the next process cycle. Since the adsorption and desorption process is achieved through pressure changes, the said method is known as pressure swing adsorption. In some embodiments, the adsorbent used in the pressure swing adsorption device 70 includes activated carbon, aluminum oxide, zeolite molecular sieves, and/or hollow fibers, etc. In some embodiments, the pressure swing adsorption device 70 is a multi-tower pressure swing adsorption device, such as a two-tower pressure swing adsorption device, a three-tower pressure swing adsorption device, a four-tower pressure swing adsorption device, etc. In the embodiment shown as FIG. 1, the pressure swing adsorption device 70 is illustrated as a three-tower pressure swing adsorption device, in which the cooled down hydrogen can selectively enter the first adsorption tower 71, the second adsorption tower 72, and/or the third adsorption tower 73 by controlling the gas valve (not shown) in the pressure swing adsorption device 70. During the purification, the pressure can be balanced between the first adsorption tower 71, the second adsorption tower 72, and the third adsorption tower 73. The purified hydrogen can enter the device connected behind through each adsorption tower. In some embodiments, the adsorption tower of the pressure swing adsorption device 70 is a multi-bed adsorption tower, such as a three-bed adsorption tower, a four-bed adsorption tower, etc.

The vacuum pump 80 is connected to the pressure swing adsorption device 70 and is used to depressurize the pressure swing adsorption device 70 during desorption process. In general, under adsorption equilibrium, for any adsorbent and a specific gas, the higher the pressure and the lower the temperature is, the greater the adsorption capacity of the adsorbent has. Conversely, with lower pressure and higher temperature, the adsorption capacity decreases. Usually, the pressure swing adsorption device performs adsorption under high pressure and room temperature and performs desorption under atmospheric pressure and high temperature. Because of the high adsorption affinity of CH₄, the desorption of CH₄ is usually performed under vacuum and high temperature. Therefore, vacuum pump 80 is introduced in the present disclosure to fulfill the adsorption under high pressure and the desorption under vacuum of the pressure swing adsorption device 70, in order to reduce the amount of hydrogen waste as well as to enhance the desorption of pressure swing adsorption device 70. During the depressurizing of the adsorption tower, the adsorbed CH₄ is desorbed from the adsorbent and discharged from the inlet of the adsorption tower.

According to some embodiments, the hydrogen charger 110 charges the hydrogen from the pressure swing adsorption device 70 to one or more metal alloy hydrogen storage tanks 120. That is, the hydrogen charger 110 can charge one or more metal alloy hydrogen storage tanks at the same time. The hydrogen passed through the pressure swing adsorption device 70 can still maintain a certain pressure (e.g. 145-200 psig), allowing the hydrogen charger 110 to charge the hydrogen passed through the adsorption device 70 directly into the metal alloy hydrogen storage tank 120. In some embodiments, the material of the metal alloy hydrogen storage tank 120 comprises LaNi₅, TiMn₂, TiFe, LaNi₃, Mg₂Ni, BCC (body-centered cubic)-TiV and Mg, etc. In some embodiments, the metal alloy hydrogen storage tank 120 has a volume of 0.1 to 5 L, such as 0.5 to 3 L, 1 to 2 L, etc.

In some embodiments, the integrated hydrogen production and charging system 1000 further includes a chiller 50 connected to the heat exchanger 40 and the hydrogen charger 110, capable of exchanging heat with the heat exchanger 40, lowering the temperature of the pressure swing adsorption device 70 and removing the heat released by hydrogen charger 110 during hydrogen charging, to ensure the metal alloy hydrogen storage tank 120 can be continuously charged with hydrogen.

According to some embodiments, the integrated hydrogen production and charging system 1000 further includes a temperature control unit 90, connected to the pressure swing adsorption device 70, controlling the temperature of the pressure swing adsorption device 70 during the desorption to be 150° C.-200° C. (for example, 155° C.-195° C., 165° C.-185° C., etc.) and the temperature during adsorption below 30° C. (e.g. 15° C.-28° C., 20° C.-25° C., etc.). In some embodiments, the waste heat generated by the hydrogen generator 10 can be used to heat up the pressure swing adsorption device 70 through the temperature control unit 90. In some embodiments, when the pressure swing adsorption device 70 needs to be cooled down, the temperature control unit 90 may also introduce cooling water from the chiller 50 for cooling.

In some embodiments, the integrated hydrogen production and charging system 1000 further includes a first buffer tank 20 between the hydrogen generator 10 and the compressor 30, in order to temporarily store the hydrogen after the first purification. The first buffer tank 20 may act as a buffer, thereby reducing system pressure fluctuations. In some embodiments, the integrated hydrogen production and charging system 1000 further includes a second buffer tank 100 between the pressure swing adsorption device 70 and the hydrogen charger 110 for temporarily storing the hydrogen after the second purification. The second buffer tank 100 may act as a pressure stabilizer during the alternating operation of the adsorption tower to ensure a continuous and stable supply of hydrogen.

In some embodiments, the integrated hydrogen production and charging system 1000 further includes a spillback path 60, which allow the hydrogen from the heat exchanger 40 flow back to the first buffer tank 20. By adjusting the pressure of the compressed hydrogen entering the pressure swing adsorption device 70, the large fluctuation in hydrogen flow can be avoided. By adding a spillback path 60 behind the heat exchanger 40, the excess amount and over compressed gas can flow back to the first buffer tank 20, which has the effect of anti-surge. Thus, it can ensure a stable input of hydrogen to the pressure swing adsorption device 70 to remove of water and methane, in order to achieve the required condition of hydrogen quality and to avoid pressure changes affecting the efficiency of the pressure swing adsorption device 70.

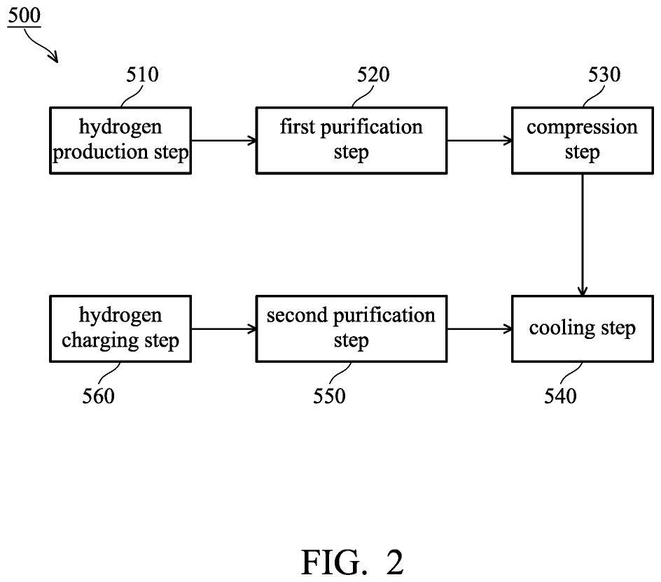

The integrated hydrogen production and charging method 500 using the integrated hydrogen production and charging system 1000 will be further described in detail below with reference to both FIG. 1 and FIG. 2, according to some embodiments. It should be noted that the integrated hydrogen production and charging method 500 can also use the systems/devices other than the integrated hydrogen production and charging system 1000. Using the integrated hydrogen production and charging method 500 of the integrated hydrogen production and charging system 1000 as an example is merely for convenience and do not limit the scope of the invention.

As shown in FIG. 2, the integrated hydrogen production and charging method 500 sequentially includes a hydrogen production step 510, a first purification step 520, a compression step 530, a cooling step 540, a second purification step 550 and a hydrogen charging step 560.

In some embodiments, the hydrogen production step 510 uses methanol solution in a methanol reforming reaction to synthesize hydrogen. For example, the methanol solution in the fuel tank 11 enters the reactor 12 to undergo a methanol reforming reaction, wherein the concentration of the methanol solution is, for example, 62 wt %±5 wt %. In some embodiments, the mechanism of hydrogen synthesis of the hydrogen generator 10 may be steam reforming. The hydrogen production step 510 may perform the steam reforming with a proper catalyst under proper temperature (for example, between 270° C. and 450° C.). The hydrogen-rich gas produced in the hydrogen production step 510 by the hydrogen generator 10 is unpurified hydrogen, and the hydrogen concentration of the hydrogen-rich gas is between about 60% and 72%. The hydrogen-rich gas still includes CO, CO₂, CH₄ and some moisture.

In some embodiments, the first purification step 520 purifies the hydrogen-rich gas produced in the hydrogen production step 510 using a palladium membrane purification device 13. In some embodiments, the hydrogen gas produced in the hydrogen production step 510 is purified by the palladium membrane purification device 13 in the hydrogen generator 10, and CO therein is methanolized. CO methanation is an effective method to remove CO in the synthesis gas, wherein precise control of the reaction temperature is essential. If the temperature is too high, the CO₂ will also undergo methanation, which will consume the hydrogen in the synthesis gas. In some embodiments, after the first purification step 520, the concentration of the hydrogen is higher than 99.95%, the water content is less than 750 ppmv (for example, 600-650 ppmv, 500-700 ppmv, etc.), CO is less than 1 ppmv (for example, 0.1-0.5 ppmv, etc.), CO₂ is less than 3 ppmv (such as 1-2 ppmv, etc.), and methane is less than 350 ppmv (such as 200-300 ppmv, 100-250 ppmv, etc.). In some embodiments, the pressure of the hydrogen after the first purification step 520 is 7-14 psig (such as 8-12 psig, 9-10 psig, etc.). The hydrogen after CO removal can be used directly in fuel cells without poisoning the cell electrode. However, the metal alloy hydrogen storage tank is highly sensitive to gas impurities, and thus further removal of CH₄ and water from the gas after CO methanation is required.

In some embodiments, the hydrogen after the first purification step 520 is compressed in the compression step 530. In some embodiments, the hydrogen purified by the palladium membrane purification device 13 in the hydrogen generator 10 is compressed to 160-215 psig (such as 175-200 psig, 180-190 psig, etc.) by the compressor 30. In some embodiments, the hydrogen after the compression step 530 is cooled down in the cooling step 540. In some embodiments, a heat exchanger 40 is used to cool down the hydrogen from the compressor 30 to below 30° C. (e.g. 15° C.-28° C., 20° C.-25° C.) while removing condensate and reducing the burden on the pressure swing adsorption device 70 behind.

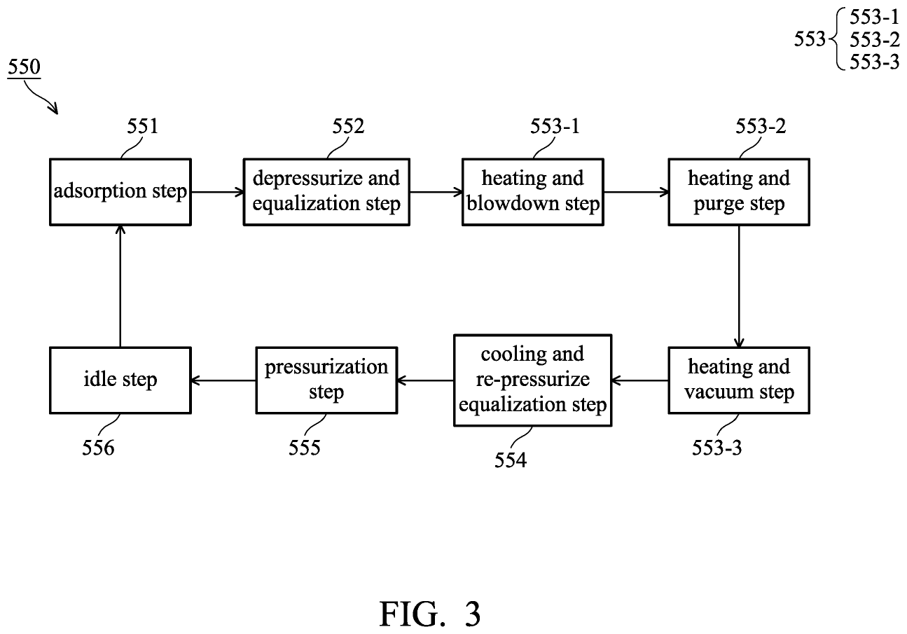

In some embodiments, in the second purification step 550, the pressure swing adsorption device 70 purifies the hydrogen after the cooling step 540. Then referring to FIG. 3, in some embodiments, the second purification step 550 is performed by multi-tower pressure swing adsorption device, wherein the multiple adsorption towers of the multi-tower pressure swing adsorption device alternately perform different steps in the process cycle of the adsorption and desorption of impurities for regeneration at the same time. The process cycle sequentially includes at least an adsorption step 551, a depressurize and equalization step 552, a heating and blowdown step 553-1, a heating and purge step 553-2, a heating and vacuum step 553-3, a cooling and re-pressurize equalization step 554, a pressurization step 555 and an idle step 556. The heating and blowdown step 553-1, heating and purge step 553-2, and heating and vacuum step 553-3 are collectively referred to as a desorption step 553. In some embodiments, the hydrogen passes through the multi-tower pressure swing adsorption device 70, wherein one of the towers lowers the water content of the hydrogen to below 5 ppmv (such as below 3 ppmv, below 1 ppmv), and eliminates methane to below 50 ppmv (such as below 30 ppmv, below 10 ppmv). At the same time, other towers perform regeneration, and then the towers alternate with each other to perform continuous adsorption and desorption operations.

Referring to both FIG. 1 and FIG. 3, in some embodiments, the first adsorption tower 71 first performs the adsorption step 551, adsorbing impurities in the hydrogen after the cooling step 540, until the first adsorption tower 71 is nearly saturated. In some embodiments, the temperature during adsorption is lower than 30° C. (such as 15° C.-28° C., 20° C.-25° C.). The first adsorption tower 71 then performs a depressurize and equalization step 552 to balance the pressure between the first adsorption tower 71 and the second adsorption tower 72 performing the cooling, and re-pressurize equalization step.

In some embodiments, the first adsorption tower 71 then performs a desorption step 553. In some embodiments, the temperature during the desorption of the second purification step 550 is 150° C. to 200° C. (e.g., 160-190° C., 170-180° C.). The heating and blowdown step 553-1 discharges impurities from the first adsorption tower 71. As the temperature rises, the adsorption capacity of the adsorbent decreases, so that the impurities adsorbed earlier on the adsorbent can be desorbed. In the subsequent heating and purge step 553-2, the impurities discharged from the first adsorption tower 71 are purged by the introduction of purge gas into the adsorption tower, and the impurities desorbed from the adsorbent are blown out of the adsorption tower. Then the heating and vacuum step 553-3 is performed to reduce the pressure of the first adsorbent tower 71 to less than 7 psia (e.g., less than 3 psia, less than 1 psia, etc.) by the vacuum pump 80, further reducing the adsorption capacity of the adsorbent to release the residual impurities in the first adsorption tower 71, and removing the impurities that have been desorbed due to the drop in pressure.

In some embodiments, the first adsorption tower 71 then performs the cooling and re-pressurize equalization step 554, so that the pressure of the first adsorption tower 71 and the pressure of the third adsorption tower 73 performing the depressurize and equalization step are balanced. Next, a pressurization step 555 is performed to raise the pressure of the first adsorption tower 71 to the adsorption pressure. Finally, the first adsorption tower 71 enters the idle step 556 and waits for the next process cycle.

It should be noted that other adsorption towers perform the same process cycle at the same time, but different adsorption towers perform different steps in the process cycle, which are not repeated here.

In purified hydrogen gas, H₂ purity is higher than 99.99%, water content is less than 5 ppmv, carbon monoxide is less than 1 ppmv, carbon dioxide is less than 3 ppmv, methane is less than 10 ppmv, and the pressure can be maintained at 145-200 psig. The quality of hydrogen can meet the quality requirements of ISO14687 and that of hydrogen storage alloys.

In some embodiments, the hydrogen charging step 560 charges the hydrogen gas after the second purification step 550 into one or more metal alloy hydrogen storage tanks 120. In some embodiments, the hydrogen filling step 560 fills, for example, 10 1.0-liter hydrogen storage tanks (hydrogen storage 45 g/tank) within 2 hours to supply hydrogen energy vehicles.

It should be noted that additional steps may be provided before, during and after the method 500, for example, between the first purification step 520 and the compression step 530 may further include a first buffer step, and between the second purification step 550 and hydrogen charging step 560 may further include a second buffering step.

The integrated hydrogen production and charging system in the present disclosure generates low-pressure hydrogen by methanol reforming. Additionally, by using a compressor to compress the hydrogen, the hydrogen can still maintain 145-200 psig after being purified by a pressure swing adsorption device and can be charged into metal alloy storage tanks. This enables the rapid filling of metal alloy hydrogen storage tanks or the fulfilling of the concept of hydrogen tank exchange. The integrated hydrogen production and charging system in the present disclosure may also be used for the construction of the low-pressure hydrogen fueling station. The pressure of present high-pressure hydrogen storage stations generally reaches above 5,000 psig, the requirements for safety are relatively high, so it is difficult to reduce the construction cost and speed. However, with the integrated hydrogen production and charging system of the present invention, methanol solution can be stored or transported in liquid form and produce hydrogen on-demand. In addition, because the system stores hydrogen in low-pressure metal alloy tanks that has higher safety, it can speed up the construction of regional low-pressure hydrogen fueling stations at low cost and realize the promotion of hydrogen energy.

With the invention of the present disclosure, the concept of hydrogen tank exchange can also be realized. For example, by filling the hydrogen storage tank in the hydrogen production plant, then distributing the hydrogen storage tank to the exchange station (for example, gas stations, convenience stores, etc.) through the distribution center and stocking up the tank in the distribution center, the empty tanks used by consumers can be directly exchanged for new tanks fully filled with hydrogen. This greatly improves the convenience of hydrogen refueling, thereby accelerating the promotion of the use of hydrogen.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An integrated hydrogen production and charging system, comprising:
a hydrogen generator to generate hydrogen by methanol reforming and to make the generated hydrogen pass through a palladium membrane purification device in the hydrogen generator for a first purification;
a compressor to compress the hydrogen from the hydrogen generator;
a heat exchanger, connected to the compressor, to cool down the compressed hydrogen;
a pressure swing adsorption device, connected to the heat exchanger, to perform a second purification on the cooled down hydrogen by adsorption;
a vacuum pump, connected to the pressure swing adsorption device, to depressurize the pressure swing adsorption device during desorption; and
a hydrogen charger to charge the hydrogen from the pressure swing adsorption device into one or more metal alloy hydrogen storage tanks.

2. The system as claimed in claim 1, further comprising:
a chiller, connected to the heat exchanger and the hydrogen charger, to exchange heat with the heat exchanger and to remove heat releasing from the hydrogen charger during hydrogen charging.

3. The system as claimed in claim 2, further comprising:
a temperature control unit, connected to the pressure swing adsorption device, to control a temperature of the pressure swing adsorption device to 150° C.-200° C. during the desorption and below 30° C. during adsorption.

4. The system as claimed in claim 3, wherein the temperature control unit introduces waste heat generated by the hydrogen generator to heat up the pressure swing adsorption device.

5. The system as claimed in claim 3, wherein the temperature control unit introduces cooling water from the chiller to cool down the pressure swing adsorption device.

6. The system as claimed in claim 1, further comprising:
a first buffer tank, between the hydrogen generator and the compressor, to temporarily store the hydrogen after the first purification;
a second buffer tank, between the pressure swing adsorption device and the hydrogen charger, to temporarily store the hydrogen after the second purification.

7. The system as claimed in claim 6, further comprising:
a spillback path to let the hydrogen from the heat exchanger flow back to the first buffer tank.

8. The system as claimed in claim 1, wherein the pressure swing adsorption device is a multi-tower pressure swing adsorption device.

9. An integrated hydrogen production and charging method sequentially comprising:
a hydrogen production step using a methanol solution for a methanol reforming reaction to synthesize hydrogen;
a first purification step purifying the hydrogen synthesized by the hydrogen production step through a palladium membrane purification device;
a compression step compressing the hydrogen after the first purification step;
a cooling step cooling down the hydrogen after the compression step;
a second purification step purifying the hydrogen after the cooling step through a pressure swing adsorption device, and
a hydrogen charging step charging the hydrogen after the second purification step into one or more metal alloy hydrogen storage tanks.

10. The method as claimed in claim 9, wherein the hydrogen after the first purification has a water content of 500-700 pppmv and a methane concentration of 200-30 ppmv, and the hydrogen after the second purification has a water content below 5 ppmv and a methane concentration below 50 ppmv.

11. The method as claimed in claim 9, wherein the second purification step is performed by a multi-tower pressure swing adsorption device, wherein multiple towers of the multi-tower pressure swing adsorption device alternately perform different steps in a process cycle of adsorption and desorption of impurities for regeneration, wherein the process cycle sequentially comprise at least:
an adsorption step, adsorbing impurities in the hydrogen after the cooling step until a first adsorption tower is nearly saturated;
a depressurize and equalization step, balancing a pressure of the first adsorption tower and a pressure of a second adsorption tower performing a cooling and re-pressurize equalization step;
a heating and blowdown step, discharging the impurities from the first adsorption tower;
a heating and purge step, purging the impurities discharged from the first adsorption tower;
a heating and vacuum step, releasing the residual impurities in the first adsorption tower;
a cooling and re-pressurize equalization step, balancing the pressure of the first adsorption tower and a pressure of a third adsorption tower performing the depressurize and equalization step;
a pressurization step, raising the pressure of the first adsorption tower to a adsorption pressure; and
an idle step putting the first adsorption tower on standby.

12. The method as claimed in claim 10, wherein a pressure of the hydrogen after the first purification is 7-14 psig, and the pressure of the hydrogen after the second purification is 145-200 psig.

13. The method as claimed in claim 12, wherein the compression step compress the hydrogen to 160-215 psig.

14. The method as claimed in claim 10, wherein the second purification step has a pressure below 7 psia during desorption.

15. The method as claimed in claim 10, wherein the second purification step has a temperature between 150° C. and 200° C. during desorption and a temperature below 30° C. during adsorption.

16. The method as claimed in claim 10, wherein the methanol solution used in the hydrogen production step has a concentration of 62% wt %±5 wt %.

17. The method as claimed in claim 10, wherein the hydrogen charging step charges 10 hydrogen storage 1.0 liter tanks (hydrogen storage 45 g/tank) within 2 hours.
